(19) United States
(12) Patent Application Publication
(10) Pub. No.: US 2004/0008268 A1
(43) Pub. Date: Jan. 15, 2004

(54) Electronic still camera

(75) Inventors: Hirono Tsubota, Tokyo (JP); Kenichi Tanaka, Tokyo (JP); Sachiko Ozaki, Tokyo (JP); Yoshizumi Nakao, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/347,685

(22) Filed: Jan. 22, 2003

(30) Foreign Application Priority Data
Jul. 15, 2002 (JP) 2002-205771

(51) Int. Cl. H04N 5/238

(52) U.S. Cl. 348/231.3

(57) ABSTRACT

An electronic still camera includes an imaging unit for performing a photon-to-electron conversion on an incident optical image so as to generate picture data, a weather information determination unit for determining weather information when taking a picture, and a control unit for storing the picture data generated by the imaging unit in a storage unit, for storing the weather information determined by the weather information determination unit in the storage unit, and for reading the picture data and the weather information stored in the storage unit.

### BACKGROUND OF THE INVENTION

1. Field of the Invention

The present invention relates to an electronic still camera that takes a picture of an object so as to generate picture data.

2. Description of Related Art

Although prior art electronic still cameras are useful considering the fact that immediately after taking pictures users can check the taken pictures and image processing can be easily performed on the taken pictures, users have to print out those photos by using a personal computer and a printer and it is therefore desired that the image output processing is simplified.

Japanese patent application publication No. 2000-350137, “Electronic still camera and service method of reproducing recorded images” discloses a prior art technique to solve this problem. In accordance with this prior art method, photos taken using an electronic still camera, which can be rented to users, are printed out at a photo print shop and the printed photos are provided for users. Thus, in accordance with this method, users only have to bring an electronic still camera into a photo print shop and print out their photos taken by using an electronic still camera by making a request for printing. As a result, the prior art method can save users from having to print out their photos by themselves.

In such an electronic still camera, in order to make the color shade of a taken picture proper, image correction processing corresponding to shooting conditions, which is so-called white balance adjustment processing, is generally performed on the picture data on the taken picture. Image correction processing methods include a method of making an image correction to the picture data on the taken picture by estimating the color temperature of a light source using a color sensor included in the electronic still camera, and a method of making an image correction to the picture data on the taken picture by integrating pixels of the picture data on the picture taken by way of an optical lens of the electronic still camera.

However, errors can easily occur because such image correction processing does not provide accurate color temperature information, and there is a limit to the image correction processing performed by the electronic still camera because of a restriction imposed on the circuit size.

A prior art electronic still camera constructed as mentioned above is that although it can save users from having to print out their photos by themselves, it cannot perform image correction processing on the image data on taken pictures at a high speed and with a high degree of accuracy and it cannot faithfully reproduce the color of any object.

### SUMMARY OF THE INVENTION

The present invention is proposed to solve the above-mentioned problems, and it is therefore an object of the present invention to provide an electronic still camera that can save users from having to print out their photos by themselves, can perform image correction processing on the image data on taken pictures at a high speed and with a high degree of accuracy, and can faithfully reproduce the color of any object.

In accordance with an aspect of the present invention, there is provided an electronic still camera including a weather information determination unit for determining weather information when taking a picture, and a control unit for storing picture data generated by an imaging unit in a storage unit, for storing the weather information determined by the weather information determination unit in the storage unit, and for reading the picture data and the weather information stored in the storage unit.

In accordance with another aspect of the present invention, there is provided an electronic still camera including a communication unit for receiving weather information by way of a mobile telephone when taking a picture, and a control unit for storing picture data generated by an imaging unit in a storage unit, for instructing the communication unit to receive the weather information by way of the mobile telephone, for storing the weather information received by the communication unit in the storage unit, and for reading the picture data and the weather information stored in the storage unit.

In accordance with a further aspect of the present invention, there is provided an electronic still camera including a communication unit for receiving position information about a position of the electronic still camera by way of a mobile telephone when taking a picture, and a control unit for storing picture data generated by an imaging unit in a storage unit, for instructing the communication unit to receive the position information by way of the mobile telephone, for storing the position information received by the communication unit and time information held by the electronic still camera in the storage unit, and for reading the picture data, the position information and the time information stored in the storage unit.

As a result, when photos taken by the electronic still camera are printed out at a photo print shop or the like, a personal computer disposed at the photo print shop or the like, which is connected to the electronic still camera, is allowed to perform image correction processing on each picture data delivered from the electronic still camera at a high speed and with a high degree of accuracy. Therefore, the electronic still camera according to the present invention offers an advantage of being able to faithfully reproduce the color of any object.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of an electronic still camera according to embodiment 1 of the present invention; and

FIG. 2 is a block diagram showing the structure of an electronic still camera according to embodiment 2 of the present invention.

### DETAILED DESCRIPTION OF THE PREFERRED EMBODIMENTS

The invention will now be described with reference to the accompanying drawings.

Embodiment 1.

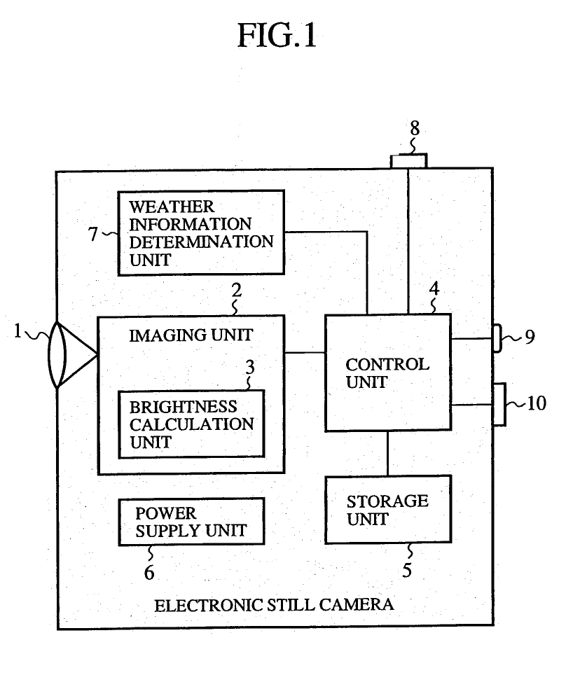

FIG. 1 is a block diagram showing the structure of an electronic still camera according to embodiment 1 of the present invention. In the figure, reference numeral 1 denotes an optical lens for forming an image, a pan focus lens being used as the optical lens 1, reference numeral 2 denotes an imaging unit for performing a photo-to-electron conversion on an optical image incident thereupon by way of the optical lens 1 so as to generate picture data with plural pixel data. An image sensor, such as a C-MOS sensor or a CCD, is used as the imaging unit 2. Reference numeral 3 denotes a brightness determination unit for determining an average of the values of brightness signals associated with pixels included in the picture data generated by the photo-to-electron conversion.

Furthermore, in FIG. 1, reference numeral 4 denotes a control unit constructed of a microcomputer or the like, for controlling the entire electronic still camera, reference numeral 5 denotes a storage unit constructed of a memory such as a DRAM, for storing the picture data generated by the imaging unit, reference numeral 6 denotes a power supply unit, a storage battery or the like that can become charged being used as the power supply unit 6, reference numeral 7 denotes a weather information determination unit for determining weather information, the weather information determination unit being constructed of an atmospheric temperature sensor for measuring atmospheric temperature and an atmospheric pressure sensor for measuring atmospheric pressure, reference numeral 8 denotes a shutter, reference numeral 9 denotes a display unit constructed of a LED or the like, and reference numeral 10 denotes an external interface unit for furnishing the picture data stored in the storage unit 5 to outside the electronic still camera.

Next, a description will be made as to an operation of the electronic still camera according to embodiment 1 of the present invention.

The control unit 4 determines a proper time required for electric charging by using the average of the values of the brightness signals calculated by the brightness determination unit 3 and also determines a time required for the photo-to-electron conversion. When the shutter 8 is pushed, the control unit 4 stores the picture data acquired by the imaging unit 2 in the storage unit 5.

When the shutter 8 is pushed and the electronic still camera takes a picture of an object, the control unit 4 acquires temperature data from the temperature sensor of the weather information determination unit 7 and acquires atmospheric pressure data from the atmospheric pressure sensor, and stores the acquired temperature data and atmospheric pressure data in the storage unit 5 as well as the picture data obtained by the imaging unit.

The display unit 9, such as a LED, can be turned on and off under control of the control unit 4 and can notify users that the remaining memory capacity decreases because of the picture data stored in the storage unit 5 and the picture taken by the imaging unit is too dark or bright because of mistakes by displaying a lighting pattern corresponding to each case.

When photos taken by the electronic still camera are printed out at a photo print shop or the like, the control unit 4 can deliver corresponding picture data and temperature data and atmospheric pressure data associated with the picture data stored in the storage unit 5, by way of the external interface unit 10, to outside the electronic still camera. A personal computer disposed at the photo print shop or the like is connected to the electronic still camera so that the personal computer can determine the season and weather, such as fine or cloudy weather, in which each picture data was taken, by using the temperature data and atmospheric pressure data associated with each picture data and delivered from the electronic still camera, and can estimate color temperature so as to perform image correction processing on each picture data.

As previously mentioned, in accordance with this embodiment 1, when taking a picture, atmospheric temperature and atmospheric pressure are measured by using a temperature sensor and an atmospheric pressure sensor disposed as the weather information determination unit 7. As an alternative, the weather information determination unit 7 can include only either one of an atmospheric temperature sensor and an atmospheric pressure sensor so as to measure atmospheric temperature or atmospheric pressure.

When a volatile memory, such as a DRAM, is used as the storage unit 5 and a storage battery that can become charged is used as the power supply unit 6, the electronic still camera can have a function of urging users to print out photos at a photo print shop or the like because the time limit of storage of picture data in the storage unit 5 is determined by the discharging period of the storage battery.

When the control unit 4 stores picture data in the storage unit 5, or when the control unit 4 delivers picture data stored in the storage unit 5, by way of the external interface unit 10, to outside the electronic still camera, for example, a personal computer disposed at a photo print shop, the control unit 4 can encrypt the picture data by delivering the picture data in a format specific to the photo print shop, for example. As a result, the electronic still camera makes it possible to prevent any picture data stored therein from being extracted by photo print shops other than the specific photo print shop.

As mentioned above, in accordance with this embodiment 1, when taking a picture, the control unit 4 acquires atmospheric temperature data and atmospheric pressure data associated with the picture by using the weather information determination unit 7 and stores them as well as obtained picture data in the storage unit 5. Therefore, when photos taken by the electronic still camera are printed out at a photo print shop or the like, a personal computer disposed at the photo print shop or the like, which is connected to the electronic still camera, is allowed to perform image correction processing on each picture data delivered from the electronic still camera at a high speed and with a high degree of accuracy by using the temperature data and atmospheric pressure data associated with each picture data. Therefore, the electronic still camera offers an advantage of being able to faithfully reproduce the color of any object.

Embodiment 2.

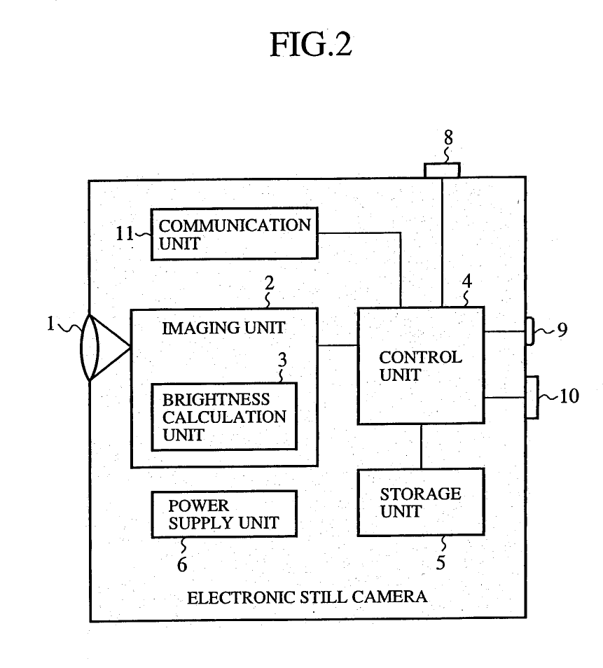

FIG. 2 is a block diagram showing the structure of an electronic still camera according to embodiment 2 of the present invention. In the figure, reference numeral 11 denotes a communication unit for communicating with a mobile telephone carried by a user of the electronic still camera. In addition, the electronic still camera according to embodiment 2 of the present invention includes the same components as those of embodiment 1 as shown in FIG. 1, with the exception that the weather information determination unit 7 is omitted. The communication unit 11 can be connected to the mobile telephone without wires. As an alternative, the mobile telephone is directly inserted into the electronic still camera so that the mobile telephone can be connected to the communication unit 11 with wires.

Next, a description will be made as to the operation of the electronic still camera according to embodiment 2 of the present invention.

When the electronic still camera takes a picture, a control unit 4 carries out a process of storing picture data in a storage unit 5, like that according to embodiment 1. The control unit 4 then instructs the mobile telephone to acquire weather information by way of a base station and the Internet through the communication unit 11. The base station then acquires weather information from a certain site by way of the Internet based on position information about the current position of the mobile telephone which the base station keeps track of, and transmits the weather information to the mobile telephone. The communication unit 11 of the electronic still camera receives the weather information from the mobile telephone, and the control unit 4 stores the weather information received as well as the picture data on a taken picture in the storage unit 5.

When photos taken by the electronic still camera are printed out at a photo print shop or the like, the control unit 4 can deliver corresponding picture data and temperature data and atmospheric pressure data associated with the picture data stored in the storage unit 5, by way of the external interface unit 10, to outside the electronic still camera. A personal computer disposed at the photo print shop or the like is connected to the electronic still camera so that the personal computer can determine the season and weather, such as fine or cloudy weather, in which each picture data was taken, by using the temperature data and atmospheric pressure data associated with each picture data and delivered from the electronic still camera, and can estimate color temperature so as to perform image correction processing on each picture data.

As previously mentioned, in accordance with this embodiment 2, when the electronic still camera takes a picture, the control unit 4 instructs the mobile telephone to acquire weather information by way of a base station and the Internet through the communication unit 11. As an alternative, the control unit 4 can instruct the mobile telephone to acquire the position information about the position of the mobile telephone which the base station keeps track of, and stores the received position information about the position of the mobile telephone and time information held by the electronic still camera as well as the picture data in the storage unit 5. Then, when taken pictures are printed out at a photo print shop or the like, a personal computer disposed at the photo print shop or the like, to which the electronic still camera is connected, can acquire weather information based on the position information about the position of the mobile telephone and the time information delivered from the storage unit 5.

As mentioned above, in accordance with this embodiment 2, when the electronic still camera takes a picture, the control unit 4 acquires either weather information or position information about the position of the mobile telephone from the mobile telephone byway of the communication unit 11, and stores either the weather information or position information about the position of the mobile telephone and time information as well as the picture data on the taken picture in the storage unit 5. Therefore, when photos taken by the electronic still camera are printed out at a photo print shop or the like, a personal computer disposed at the photo print shop or the like, which is connected to the electronic still camera, is allowed to perform image correction processing on each picture data delivered from the electronic still camera at a high speed and with a high degree of accuracy. Therefore, the electronic still camera offers an advantage of being able to faithfully reproduce the color of any object.

Many widely different embodiments of the present invention may be constructed without departing from the spirit and scope of the present invention. It should be understood that the present invention is not limited to the specific embodiments described in the specification, except as defined in the appended claims.

What is claimed is:

1. An electronic still camera comprising:
an imaging means for performing a photon-to-electron conversion on an incident optical image so as to generate picture data;
a weather information determination means for determining weather information when taking a picture; and
a control means for storing the picture data generated by said imaging means in a storage means, for storing the weather information determined by said weather information determination means in said storage means, and for reading the picture data and the weather information stored in said storage means.

2. The electronic still camera according to claim 1, wherein said weather information determination means determines atmospheric temperature and/or atmospheric pressure as the weather information.

3. An electronic still camera comprising:
an imaging means for performing a photon-to-electron conversion on an incident optical image so as to generate picture data;
a communication means for receiving weather information by way of a mobile telephone when taking a picture; and
a control means for storing the picture data generated by said imaging means in a storage means, for instructing said communication means to receive the weather information by way of said mobile telephone, for storing the weather information received by said communication means in said storage means, and for reading the picture data and the weather information stored in said storage means.

4. An electronic still camera comprising:
an imaging means for performing a photon-to-electron conversion on an incident optical image so as to generate picture data;
a communication means for receiving position information about a position of said electronic still camera by way of a mobile telephone when taking a picture; and
a control means for storing the picture data generated by said imaging means in a storage means, for instructing said communication means to receive the position information by way of said mobile telephone, for storing the position information received by said communication means and time information held by said electronic still camera in said storage means, and for reading the picture data, the position information and the time information stored in said storage means.
